(19) United States
(12) Patent Application Publication
(10) Pub. No.: US 2019/0376626 A1
(43) Pub. Date: Dec. 12, 2019

(54) APPARATUS AND METHOD FOR SECURING ELONGATE OBJECTS

(71) Applicant: Ellis Patents Holdings Limited, York (GB)

(72) Inventors: Stephen Andrew Walton, York (GB); Christopher John Calvert, York (GB)

(21) Appl. No.: 16/463,298

(22) PCT Filed: Nov. 29, 2017
(86) PCT No.: PCT/GB2017/053595

§ 371 Date: May 22, 2019

(30) Foreign Application Priority Data
Dec. 2, 2016 (GB) 1620469.5

(51) Int. Cl. F16L 3/12; F16L 3/23; H02G 3/32

(52) U.S. Cl. CPC F16L 3/1211; H02G 3/32; F16L 3/23

(57) ABSTRACT

The present invention provides apparatus for retaining a channel nut (216) member in a desired location in respect to a channel support member (104) such as a channel strut, comprising: a retainer body (106) comprising a base plate portion (202), for supporting a clamp member, comprising at least one rotation drive element located on an upper surface (200) of the base plate portion (202) for driving a rotation of a clamp member into a rotation of the retainer body (106); a retaining portion (218), extending from a lower surface (208) of the base plate portion (202), for retaining a channel nut (216) member in a desired location and rotational orientation with respect to the channel support member (104); and a first through hole (310) for receiving a first securing member (700), wherein the first through hole (310) extends through the base plate portion (202). The apparatus further comprises a clamp member for securing at least one elongate member (102) such as an electrical cable or a pipe; and a channel nut (216) member comprising a second through hole (604), wherein the channel nut (216) member is located within the retaining portion (218) of the retainer body (106). A method for securing at least one elongate member (102) is also provided.

### FIELD OF THE INVENTION

The present invention relates to apparatus and methods for securing one or more elongate members, such as electrical cables or pipes, with respect to a surface such as floor, ceiling or wall. In particular, but not exclusively, the present invention relates to apparatus and methods for attaching cleats, of the type suitable for securing electrical cables to a channel strut.

Electrical cables or the like are often installed in buildings, tunnels or industrial structures by fixing the electrical cables in a desired location and orientation with respect to a support surface. For example, it is common to secure electrical cables in a cleat attached to a channel strut, using a channel nut. It is known that the channel nut must be inserted into a channel of the channel strut in one orientation, rotated and thereafter maintained within the channel strut in the correct orientation before securing the cleat to the channel strut using the channel nut.

Inserting a channel nut and maintaining it in the correct orientation can be fiddly and requires dexterity which can be difficult especially when there is limited light and/or space for a user to work or when conditions are wet and/or cold. Additionally a user may be wearing gloves or other protective clothing that may reduce dexterity.

Conventionally locating a cleat for securing cables or pipes, in a desired location with respect to a channel strut, requires the assembly of a number of parts on site. Firstly a channel nut needs to be located and maintained within the channel strut, secondly the cleat needs to be located on an outer surface of the channel strut above the channel nut and a bolt needs to be inserted into a through hole extending through a portion of the cleat and through a through hole of the channel nut. The bolt is then tightened to urge the channel nut into contact with two opposed downward facing hook like structures of the channel strut. The assembly of these parts can be difficult and time consuming as this involves a number steps. These methods are also prone to user error due to the cleat being misaligned with the channel nut, leading to the cleat not being robustly secured when the bolt is inserted and tightened as well as causing cross threading of the bolt into the channel nut. There is also a disadvantage in that the parts must be shipped and assembled separately therefore increasing costs and risking the loss of one or more parts of the assembly.

Conventionally certain channels nuts have been held in a channel strut by a channel nut retainer. The retainer and thus the channel nut must first be rotated before locating an object on the retainer, which then must be subsequently secured using a bolt. This offers the disadvantage that the process is slow and laborious as the object has to be carefully aligned laterally and rotationally with the retainer and channel nut.

It is an aim of the present invention to at least partly mitigate the above-mentioned problems.

It is an aim of certain embodiments of the present invention to provide apparatus for securing one or more elongate members, which is easily and quickly secured at a desired location.

It is an aim of certain embodiments of the present invention to provide apparatus for securing one or more elongate members that is easy and quick to secure in low light, cold and/or wet conditions.

It is an aim of certain embodiments of the present invention to provide integral apparatus for locating and maintaining a channel nut member and a clamp member in a desired location and orientation with respect to a channel support member.

It is an aim of certain embodiments of the present invention to provide apparatus for securing one or more elongate members that can be easily secured to a downward facing surface.

It is an aim of certain embodiments of the present invention to provide apparatus for retaining and orientating a channel nut in a convenient manner by a rotation of a clamp member.

It is an aim of certain embodiments of the present invention to provide a method of securing one or more elongate members in a desired location whereby rotation of a channel nut member is driven by rotation of a clamp member.

According to a first aspect of the present invention there is provided apparatus for securing at least one elongate member at a desired location, comprising:
a clamp member for securing at least one elongate member;
a retainer body, comprising;
   a base plate portion, for supporting a clamp member, comprising at least one rotation drive element located on an upper surface of the base plate portion for driving a rotation of a clamp member into a rotation of the retainer body;
   a retaining portion, extending from a lower surface of the base plate portion, for retaining a channel nut member in a desired location and rotational orientation with respect to a channel support member; and
   a first through hole for receiving a first securing member, wherein the first through hole extends through the base plate portion; and
a channel nut member, comprising a second through hole, wherein the channel nut member is located within the retaining portion of the retainer body.

Aptly, the clamp member is locatable on the upper surface of the base plate portion of the retainer body.

Aptly, the at least one rotation drive element comprises at least one protrusion outwardly extending from the upper surface of the base plate portion.

Aptly, the protrusion comprises two substantially parallel elongate spaced apart protrusions located at opposing edges of the upper surface of the base plate portion.

Aptly, the retaining portion comprises, a first stop surface and a further stop surface opposed to and spaced from the first stop surface by at least one spacer element.

Aptly, said spacer element and stop surfaces define an aperture for receiving the channel nut member.

Aptly, the first through hole extends through at least one of the first and/or further stop surfaces.

Aptly, the clamp member comprises:
a mounting portion for mounting at least one elongate member;
at least one securing element for securing at least one elongate member;
at least one flange element for receiving a further securing member; and
a further through hole extending through the mounting portion.

Aptly, the clamp member is locatable so that the first through hole is substantially coaxially aligned with the further through hole.

Aptly, the channel nut member is locatable so that the second through hole is substantially coaxially aligned with the first and further through holes.

Aptly, the apparatus further comprises at least one tooth element for loosely securing a first securing member in the first through hole.

Aptly a region of the second through hole is threaded.

Aptly, the apparatus further comprises a first securing member locatable so as to extend through each of the first and further through holes and at least partially into the second through hole.

Aptly, a region of the first securing member is threaded.

Aptly, the channel nut member comprises at least one abutment element for abutting at least one corresponding channel abutment element of a channel support member.

Aptly, the channel nut member has a width substantially equal to or less than a width of an opening, said opening located within the channel support member.

Aptly, the channel nut member has a length greater than a width of an opening, said opening located within the channel support member.

Aptly, the channel nut member comprises two ends comprising an arcuate surface.

Aptly, the at least one securing element is shaped for extending substantially around at least a surface of the mounting portion.

Aptly, the at least one securing element comprises two side portions, located between respective ends of the securing element.

Aptly, the further through hole extends through a portion of the securing element.

Aptly, the at least one securing element is substantially flexible.

Aptly, the at least one securing element comprises at least one hinge element.

Aptly, the at least one securing element comprises a liner element located on at least one surface of the securing element.

Aptly, the liner element is manufactured from a plastic material.

Aptly, the at least one securing element is manufactured from metal.

Aptly, the at least one flange element comprises two corresponding reinforced apertures each located at respective ends of the securing element.

Aptly, the clamp member further comprises at least one base pad member locatable on a first surface of the mounting portion.

According to a second aspect of the present invention there is provided a method for securing at least one elongate member, comprising the steps of:
locating a channel nut member at a desired location within a channel of a channel support member in a first rotational orientation, wherein the channel nut member is retained in a retaining portion of a retainer body;
rotating the channel nut member to locate the channel nut member in a further rotational orientation, whereby a rotation of the channel nut member is driven by a rotation of a clamp member located on an upper surface of a base plate portion of the retainer body;
engaging a first securing member, whereby engaging the first securing member urges the channel nut member to abut at least one channel abutment element of the channel support member;
locating at least one elongate member within the clamp member; and
securing the at least one elongate member within the clamp member.

Aptly, the method further comprises:
loosely securing the first securing member within a first through hole of the retaining body by providing at least one tooth element extending at least partly into the first through hole, prior to locating the channel nut member at a desired location.

Aptly, rotation of the retainer body is driven, from the clamp member, by at least one rotation drive element located on an upper surface of the base plate portion of the retainer body, thereby driving rotation of the channel nut member.

Aptly, the method further comprises:
preventing a movement of the clamp member by providing a channel nut member comprising a length greater than a width of an opening of the channel support member.

Aptly, the method further comprises:
restricting the rotation of the channel nut member by providing a channel nut member comprising two ends comprising an arcuate surface.

Aptly, the method further comprises:
securing the at least one elongate member within the clamp member by actuating at least one side portion located between the respective ends of the securing element, said side portions comprising at least two flange elements each comprising a reinforced aperture for receiving a further securing member;
locating a further securing member within the reinforced apertures; and
engaging the further securing element.

According to a third aspect of the present invention there is provided apparatus for retaining a channel nut member in a desired location in respect to a channel support member, comprising:
a retainer body, comprising:
   a base plate portion, for supporting a clamp member, comprising at least one rotation drive element located on an upper surface of the base plate portion for driving a rotation of a clamp member into a rotation of the retainer body;
   a retaining portion, extending from a lower surface of the base plate portion, for retaining a channel nut member in a desired location and rotational orientation with respect to a channel support member; and
   a first through hole for receiving a first securing member, wherein the first through hole extends through the base plate portion.

Aptly, the at least one rotation drive element comprises at least one protrusion outwardly extending from the upper surface of the base plate portion.

Aptly, the protrusion comprises two substantially parallel elongate spaced apart protrusions located at opposing edges of the upper surface of the base plate portion.

Aptly, each of the protrusions comprises at least one mating element for mating with at least one respective inwardly extending recess located on the clamp member.

Aptly, the at least one rotation drive element comprises at least one recess, inwardly extending into the upper surface of the base plate portion, for mating with at least one corresponding outwardly extending protrusion located on the clamp member.

Aptly, each of the recesses comprises two substantially parallel elongate spaced apart recesses located at opposing edges of the upper surface of the base plate portion.

Aptly, the retaining portion comprises a first stop surface and a further stop surface opposed to and spaced from the first stop surface by at least one spacer element.

Aptly, said spacer element and stop surfaces define an aperture for receiving the channel nut member.

Aptly, each spacer element comprises at least one sidewall extending between the first and further stop surfaces.

Aptly, each sidewall element has a length greater than a thickness of the channel nut member.

Aptly, the apparatus further comprises at least one tooth element for loosely securing a first securing member in the first through hole.

Aptly, each tooth element comprises a protrusion extending at least partly into the first through hole.

Aptly, the first through hole extends through at least one of the first and/or further stop surfaces.

Aptly, the first securing member is a bolt.

Aptly, a region of the bolt is threaded.

Aptly, the retainer body is manufactured from a plastic material.

Aptly, the plastic material is a low smoke fuel nylon.

Aptly, the low smoke fuel nylon is polypropylene.

Aptly, the retainer body is manufactured from metal.

According to a fourth aspect of the present invention there is provided apparatus for securing at least one elongate member at a desired location, comprising:
a clamp member for securing at least one elongate member;
a retainer body, comprising:
   a base plate portion, for supporting a clamp member;
   a retaining portion, extending from a lower surface of the base plate portion, for retaining a channel nut member in a desired location and rotational orientation with respect to a channel support member; and
   a first through hole for receiving a first securing member, wherein the first through hole extends through the base plate portion; and
a channel nut member, comprising a second through hole, wherein the channel nut member is located within the retaining portion of the retainer body,
wherein the clamp member and retaining body are integrally formed.

According to a fifth aspect of the present invention there is provided a method for securing at least one elongate member, comprising the steps of:
locating a channel nut member at a desired location within a channel of a channel support member in a first rotational orientation, wherein the channel nut member is retained in a retaining portion of a retainer body;
rotating the channel nut member to locate the channel nut member in a further rotational orientation, whereby a rotation of the channel nut member is driven by a rotation of a clamp member, wherein the retainer body and the clamp member are integrally formed;
engaging a first securing member, whereby engaging the first securing member urges the channel nut member to abut at least one channel abutment element of the channel support member;
locating at least one elongate member within the clamp member; and
securing the at least one elongate member within the clamp member.

According to a sixth aspect of the present invention there is provided apparatus substantially as described herein with reference to the accompanying drawings.

According to a seventh aspect of the present invention there is provided a method substantially as described herein with reference to the accompanying drawings.

Certain embodiments of the present invention reduce the time needed for securing one or more elongate members such as electrical cables or pipes at a desired location.

Certain embodiments of the present invention reduce the risk of misaligning a clamp member such as a cleat with respect to a channel nut member.

Certain embodiments for the present invention reduce the risk of cross threading a securing member such as a bolt that extends into a thorough hole of a channel nut member.

Certain embodiments of the present invention reduce the number of parts needed to be assembled on site for securing one more electrical cables or pipes or the like in a desired location.

Certain embodiments of the present invention provide a simple and quick method for maintaining a channel nut member in a desired location and orientation with respect to a channel support member such as a channel strut or unistrut or the like.

Certain embodiments of the present invention provide a simple method of aligning a channel nut member and a clamp member such as a cleat or clamp or the like at a desired location and orientation with respect to a channel support member such as a channel strut or unistrut or the like.

### DESCRIPTION OF THE DRAWINGS

Certain embodiments of the present invention will now be described hereinafter, by way of example only, with reference to the accompanying drawings in which:

FIG. 1 illustrates a face on view of three electrical cables secured within a cleat located at a desired location on a channel strut;

FIG. 2 illustrates a side view of the electrical cables and cleat shown in FIG. 1;

FIG. 3 illustrates a cross section of a retainer body;

FIG. 4 illustrates a view of an upper surface of the retainer body;

FIG. 5 illustrates an underside view of a lower surface of the retainer body;

FIG. 6 illustrates a plan view of a channel nut; and

FIG. 7 illustrates modes of operation of a cleat and retainer body.

### DETAILED DESCRIPTION

In the drawings like reference numerals refer to like parts.

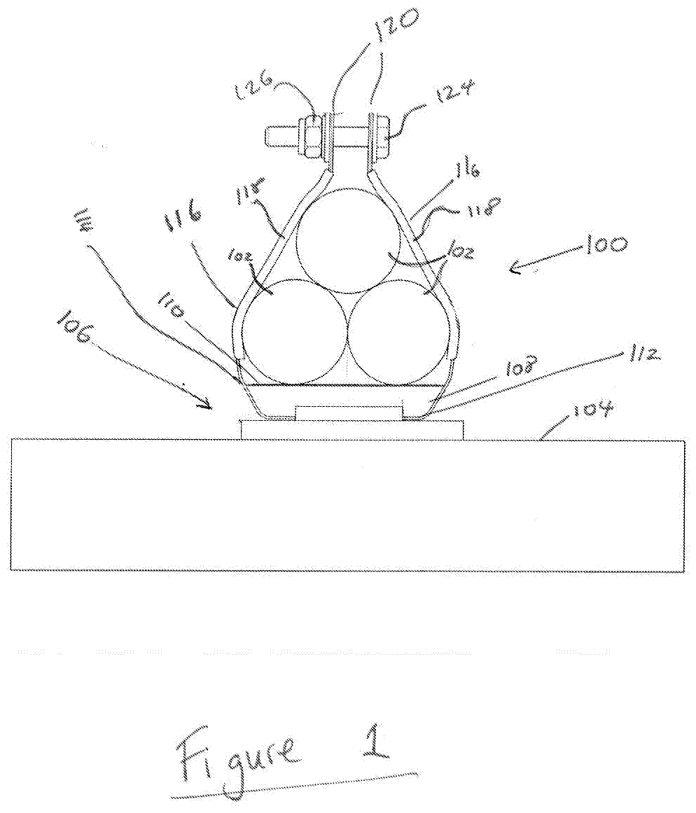

FIG. 1 illustrates a clamp member such as a cleat or clamp or the like for securing one or more elongate members 102 such as one or more electrical cables, pipes, umbilicals or the like. In FIG. 1 a cleat 100 is shown and this is located at a desired position on a channel support member 104 such as a channel strut, unistrut or the like. A channel strut 104 is shown in FIG. 1. Interposed between the cleat 100 and the channel strut 104 is a retainer body 106.

In the embodiment shown in FIG. 1 the cleat 100 has a mount 108 for resting electrical cables on, other suitable mounting portions will be known to those skilled in the art. The mount may be manufactured from a plastic material such as a low smoke low fume material or the like. The use of a low smoke low fume material can help reduce the amount of smoke and fumes produced if the cleat is exposed to elevated temperatures such as if a short circuit appears. Aptly the low smoke low fume material may be a low smoke low fume nylon. In certain embodiments the mount is manufactured from a low smoke fume zero halogen material. Such materials may help to reduce the amount of toxic fumes released if the cleat is exposed to elevated temperatures. Aptly the mount may be manufactured from a metal such as steel, stainless steel, zinc or the like. Other suitable materials will be known by those skilled in the art.

In the embodiment shown in FIG. 1 the mount 108 has a substantially planar upper surface 110 which two of the electrical cables 102 rest on, the third electrical cable 102 is rests on an upper outer surface of the two lower electrical cables 102. It will be understood that other suitable arrangements for any number of electrical cables and different clamps or cleats or the like may be used. In certain embodiments the upper surface 110 of the mount 108 may be shaped so as to conform to the shape of the electrical cables that are rested on the upper surface 110 of the mount 108. For example the upper surface of the mount may be arcuate or have recesses similar to the shape of the electrical cables. Optionally one or more base pad members such as a base pad (not shown) may be positioned on the upper surface of the mount for reducing the space available within a securing element of the cleat when a fewer number of elongate members or elongate members with a smaller cross section than the electrical cables shown in FIG. 1 are to be secured. The mount 108 also has a lower surface 112 which is spaced apart from and substantially parallel to the upper surface 110. The lower surface 112 of the mount is substantially planar and contacts an inner surface of a central portion of a strap 114. The central portion of the strap is configured to be substantial parallel to the lower surface of the mount. An outer surface of the central portion of the strap 114 provides a substantially flat base for supporting the cleat 100. Optionally as an alternative the strap and mount may be integrally formed. The strap 114 provides a securing element for securing electrical cables or pipes or the like, other suitable securing elements will be known by those skilled in the art.

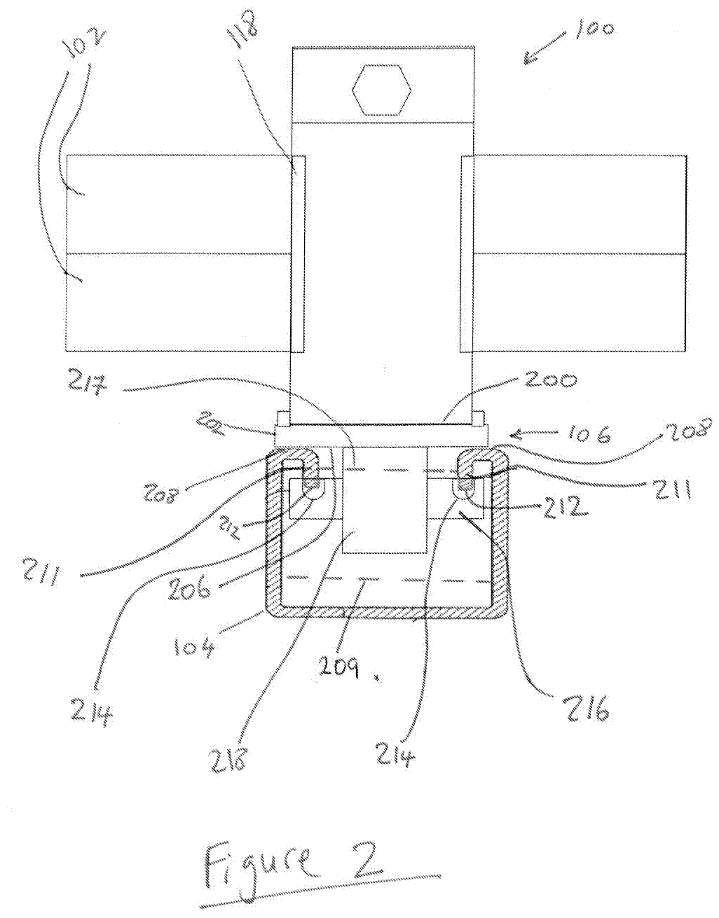

The strap 114 has two sides 116 that extend upwardly from the central portion of the strap and partially encircle the three electrical cables 102. The sides 116 illustrated in FIG. 1 include a liner 118 that is wrapped around the inner surface of the sides 116 and their edges and may extend to the outer surface (see FIG. 2) of the strap. In certain embodiments the liner is located on only one surface of the sides. Aptly the liner may extend along a whole length of the strap. The liner may be manufactured from a plastic material such as a low smoke low fume plastic, low smoke fume zero halogen material or the like. In certain embodiments the liner may not be included. At respective ends of the strap 114 are flanges 120 that are reinforced by folding the respective ends of the strap back onto itself. It will be appreciated that other suitable methods of forming flange elements and reinforcing them may be used. A reinforced aperture for receiving a securing member extends through the each of the flanges 120, suitable methods of providing an aperture will be known by those skilled in the art.

In the embodiment shown in FIG. 1 the sides 116 are suitably flexible to allow for them to be actuated in opposite directions away from each other, therefore allowing the input of the three electrical cables 102 between the sides 116. In certain embodiments the sides may be rigid and include one or more hinges or hinge elements for allowing the sides to be moved apart, therefore allowing the three electrical cables 102 (or other desired elongate objects in a desired number) to be inserted. Once the three electrical cables 102 have been inserted the sides 116 are actuated towards each other so as to secure the electrical cables 102 between the sides 116. A bolt 124 is then inserted through the reinforced apertures and a nut 126 is tightened onto the shaft of the bolt 124 securing the sides 116 together and therefore enclosing and securing the electrical cables 102. The bolt and the nut provide one example of a suitable securing member, other suitable securing members will be known by those skilled in the art.

As illustrated in FIG. 2 the cleat 100 rests on a substantially planar upper surface 200 of a base plate portion 202 of the interposed retainer body 106. Spaced apart from and substantially parallel to the upper surface 200 of the base plate portion is a lower surface 206 that abuts two spaced apart upper abutment surfaces 208 of the channel strut 104 in use thus supporting the cleat 100 on the channel strut 104.

The channel strut 104 includes a frame structure formed from a lower wall and two spaced apart substantially parallel upwardly extending sidewalls that define a channel 209 between the two upward extending sidewalls that extends a length of the channel strut. The channel strut can be rigidly secured to a wall or floor or ceiling or other such surface. The respective ends of the sidewalls are folded inwardly to provide the two spaced apart upper abutment surfaces 208 orthogonal to the sidewalls. The respective ends of the upwardly extending sidewalls are further folded downwardly into hooked ends 211 to provide two downwardly facing lower abutment surfaces 212 at the tips of the sidewalls, for abutting with corresponding spaced apart inwardly extending notches 214 located on a first surface of a channel nut 216. It will be appreciated that in certain embodiments the hooked ends of the channel strut may be formed by bending the respective ends of the sidewalls into a semi-circular shape rather than orthogonally to the side walls, in such embodiments the upper abutment surface would be arcuate. The hooked ends provide one or more channel abutment elements for abutting one or more abutment elements (for example the notches 214) of the channel nut. In certain embodiments the abutment elements of the channel nut may be and/or include grooves or cross-hatched etching for increasing friction between the abutment elements of the channel nut and the channel abutment elements (for example the hooked ends 211) of the channel strut. The hooked ends 211 are spaced apart across a width 217 of the channel strut and define an opening that is slot like for receiving the channel nut 216 retained in a retaining portion 218 of the retainer body. The channel nut 216 has a width that is less than the width 217 of the opening of the channel strut and a length greater than the width 217 of the opening of the channel strut and substantially equal to a width of the channel 209 of the channel strut.

In use the channel nut 216, retained in the retainer body 106 is inserted into the channel 209 of the channel strut 104 via the opening of the channel strut in a first orientation and then the retainer body 106 is rotated, thus rotating the channel nut 216 so as to be orientated lengthwise within the channel strut. The rotation of the retainer body may be driven by a rotation of the cleat. To secure the cleat 100 to the channel strut the channel nut 216 is urged upwards so that the two notches 214 abut the two lower abutment surfaces 212 of the hooked ends 211. This is achieved by turning a bolt or other suitable securing member, that extends through a through hole that extends through the mount and central portion of the strap and through the upper surface 200, the lower surface 208 and material of the base plate portion 202 of the retainer body 106, via through hole extending through the channel nut 216. As the bolt is rotated a threaded region of the bolt engages with a threaded portion of the through hole extending through the channel nut to move the channel nut as the bolt turns.

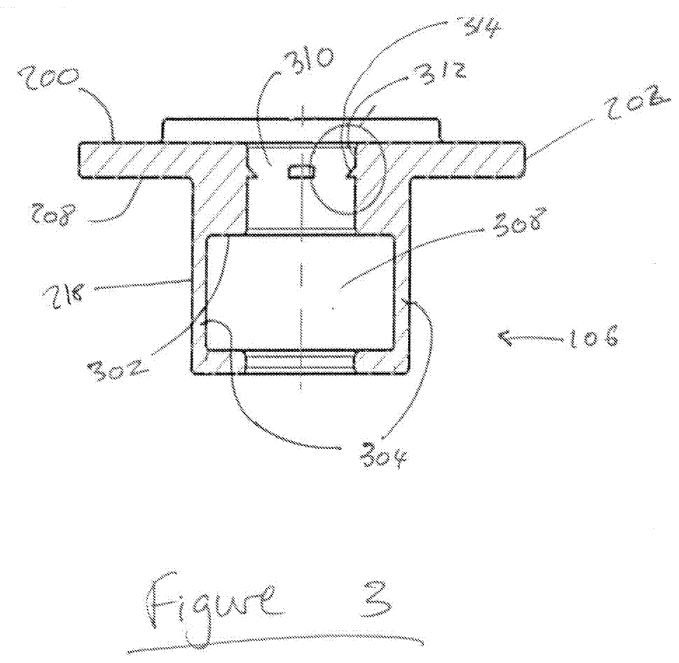

FIG. 3 provides a more detailed view of a retainer body 106 in cross section. The retainer body 106 includes a base plate portion 202 and a retaining portion 218. The base plate portion 202 of the retainer body includes a substantially planar upper surface 200 for supporting a clamp member such as the cleat. Spaced apart from and substantially parallel to the upper surface 200 of the base plate portion is a lower surface 208 of the base plate portion that abuts the upper abutment surfaces of a channel strut in use. Extending downwards from the lower surface 208 of the base plate portion is a channel nut retaining portion 218 which includes a first stop surface 302 spaced from the lower surface 208 of the base plate portion in the embodiments shown by a distance that is less than a length of the downwardly extending hooked ends of the channel strut so that when in use the channel nut retained in the retainer body can engage with the hooked ends of the channel strut. Spaced from the first stop surface 302 by two downwardly extending spaced apart opposing sidewalls 304, is a further stop surface 306. Other suitable spacer elements and arrangements of spacer elements may be envisaged. The two stop surface are for stopping a channel nut retained in the retaining portion of the retainer body from falling out of the retainer body whether the retainer body is located on a channel strut with its opening facing downwards (i.e. a channel strut located on a ceiling) or with the channel facing upwards (i.e. a channel strut located on a floor). In the embodiment shown the sidewalls 304, are spaced apart by a distance that is substantially equal to the width of the channel nut so that when the channel nut is inserted between the two side walls friction between the side surfaces of the channel nut and inner surfaces of the sidewalls prevent the channel nut from relocating without an input of force. The length of the sidewalls 304 in the embodiment shown is greater than a thickness of the channel nut so that a channel nut can move vertically between the two stop surfaces when driven by the bolt. When a channel nut is inserted into an aperture 308 defined by the sidewalls 304 and the first stop surface 302 and further stop surface 306 the channel nut is retained in a single rotational orientation within the aperture 308 by the sidewalls 304 but is able to move vertically (as seen in FIG. 7C) between the first stop surface 302 and the second stop surface 308. Thus when in use this arrangement allows the channel nut 216 to be driven to abut the downward facing lower abutment surfaces of the channel strut without being able to rotate separately to the retainer body.

A through hole 310 extends through the upper surface 200, lower surface 208 and material of the base plate portion 202 and through the first stop surface 302 and the second stop surface 306 of the retaining portion 218. Optionally as an alternative the through hole may not extend through the lower stop surface. Extending into a part of the through hole 310 from an inner wall 312 of the through hole 310 are a plurality of outwardly protruding ears 314 located radially around the inner wall 312 (two shown in cross section in FIG. 3). The ears are for abutting the bolt or other such member inserted into the through hole thus loosely securing the bolt within the through hole.

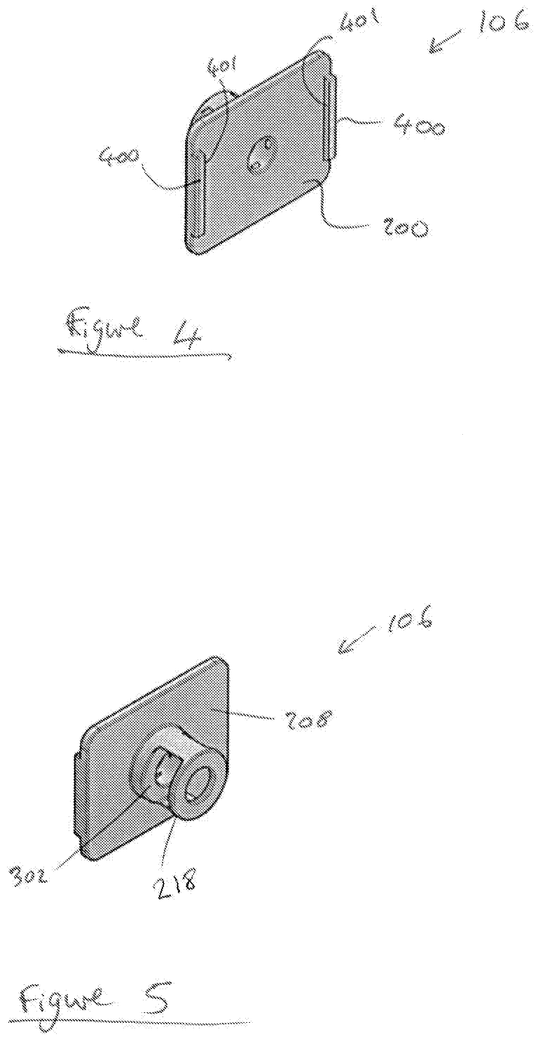

Referring to FIG. 4 a view of the upper surface of the retainer body 106 is shown. Two spaced apart and substantially parallel elongate upstanding protrusions 400 are located on two opposing edges of the upper surface 200 of the base plate portion of the retainer body. The elongate upstanding protrusions 400 extend along a portion of the two opposed edges. It will be appreciated that in certain embodiments the upstanding protrusions may extend a whole length of two opposed edges. In certain alternative embodiments the upstanding protrusions may be located on any number of edges of the upper surface of the base plate portion. The upstanding protrusions are for providing a rotation drive element for translating a rotational force applied to the cleat supported on the upper surface of the base plate portion of the retainer body into a rotation of the retainer body. In use the cleat is supported on the upper surface of the base plate portion between the two upstanding protrusions 400 so that a rotation of the cleat causes an inner surface 401 of each of the upstanding protrusions 400 to abut an outer surface of the cleat therefore the rotation of the cleat drives a rotation of the retainer body and the channel nut retained within the retainer body. It will be appreciated that the distance which the two upstanding protrusions are spaced apart by will depend on the dimensions of the cleat or other suitable clamp member. In certain embodiments the cleat may have corresponding recesses for mating with the upstanding protrusions. It will be appreciated that the shape and number of the rotation drive elements should be selected so as to allow the rotation force to be translated to the retainer body from the cleat without deforming or breaking the rotation drive elements. It will be further appreciated that any number or arrangement of rotation drive elements may be used for example in certain alternative embodiments the one or more rotation drive elements may be recesses radially positioned on the upper surface of the retainer body for mating with corresponding protrusions located on a clamp member, other suitable arrangements may be envisaged.

A length and a width of the base plate portion 202 of the retainer body shown is greater than a width of the slot like opening of the channel strut. For example for a standard 41 mm channel strut the slot like opening has a width of 22.2 mm thus the length and width of the base plate portion is greater than 22.2 mm so that the baseplate portion can stably rest on the upper abutment surfaces of the channel strut. In the embodiment shown the upper surface of the base plate portion of the retainer body has a rounded rectangular shape. It will be appreciated that the shape of the upper surface may be any shape such as square, rectangular, circular or the like suitable for supporting a clamp member.

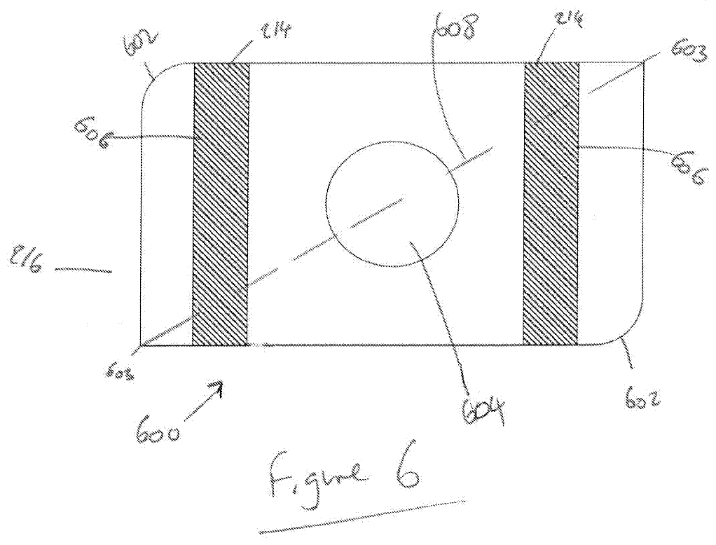

Referring to FIG. 5 a view of the lower surface of the retainer body 106 is shown. The retaining portion 218 of the retainer body has a generally cylindrical shape. Aptly the shape of the retaining portion may be any shape for example, cuboid, triangular or the like. A diameter (or a width and length) of the retaining portion 218 may be selected depending on the channel strut used. The retaining portion 218 shown is able to be passed through the slot like opening of the channel strut locating the channel nut retained therein into the channel. For example for a standard 41mm channel strut the opening of the channel strut is 22.2 mm, thus the retaining portion would have a diameter less than 22.2 mm. Aptly the diameter of the retaining portion of the retainer body is substantially equal to the width of the opening so as to reduce the degree of movement laterally in a plane parallel to the channel strut and perpendicular to the channel of the channel strut is reduced. The distance that the retaining portion of the retainer body extends from the lower surface 208 of the base plate portion (a depth of the retaining portion) may also be selected depending on the dimensions of the channel strut used. The depth of the retaining portion shown is substantially equal to or less than a length of the sidewalls of the channel strut. For example for a standard 41 mm×41mm channel strut the length of the sidewalls is 41 mm. Thus if the retainer body is for use with a standard 41 mm×41 mm channel strut the depth of the retaining portion of the retainer body should substantially equal to or less than 41 mm so that the baseplate portion can stably support a clamp member on the channel strut. The distance that the first stop surface 302 is spaced from the lower surface 208 of the base plate portion may also be selected depending on the dimensions of the channel strut used. This is to say that the first stop surfaces should be located above the tips of the hooked ends of the channel strut, so that in use the channel nut can abut the downward facing lower abutment surfaces of the channel strut.

The retainer body may be manufactured from a plastic material such as a low smoke low fume material or the like. Aptly the low smoke low fume material is a low smoke low fume nylon. Aptly the retainer body may be manufactured from a metal or metal alloy for example one or more of such as steel, stainless steel, zinc or the like. Other suitable materials will be known by those skilled in the art. In certain embodiments the retainer body and the clamp member may be integrally formed. In such embodiments the rotation drive elements may not be included. The retainer body may be manufactured using any suitable methods such as injection moulding, extrusion, welding or the like.

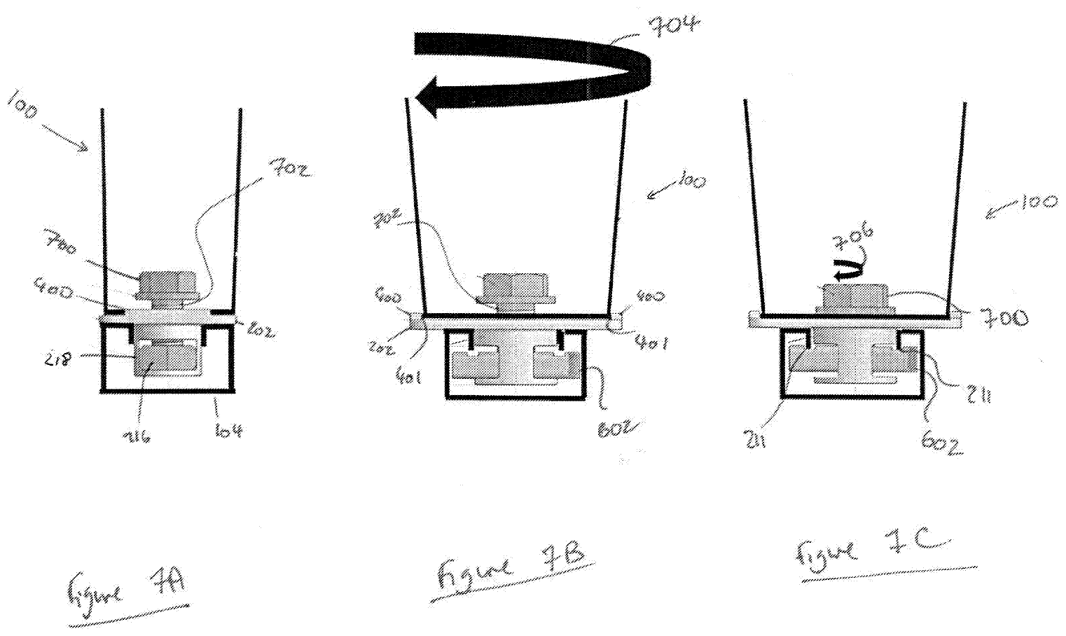

Referring to FIG. 6 a plan view of a channel nut useable with the retainer body is shown. The channel nut 216 has a substantially planar first surface 600 and second surface substantially parallel to and spaced apart from the first surface (not shown). The channel nut has two arcuate surfaces 602 diagonally opposed to each other. Each arcuate surface extends a short distance into straight edges and the straight edges meet at substantially perpendicular diagonally opposed corners 603. In certain embodiments the channel nut may be rhomboid shaped. A through hole 604 extends through the first and second surface and material of the channel nut. The through hole may be configured for engaging with a securing member such as a bolt, for example a region of the through hole may be threaded so as to engage with a threaded region of a bolt. The through may be provided by any suitable method such as boring, or stamping or the like. Extending across the first surface 600 of the channel nut are two substantially parallel notches 214 for engaging with the lower abutment surfaces of the channel strut. In the embodiment shown in FIG. 6 the inner surfaces of the notches have parallel grooves 606 for increasing friction between the lower abutment surfaces of the channel strut and the notches therefore helping to ensure the channel nut is secure when in use.

In use the channel nut retained within the retaining portion of the retainer body is inserted into a channel strut via the slot like opening of the channel strut. In the embodiment shown the channel nut is then rotated in a right handed direction about an axis coaxially aligned with the through hole 604 of the channel nut by substantially 90 degrees. Rotation of the channel nut shown in FIG. 6 by substantially 90 degrees in a left handed direction is restricted by the two diagonally opposed corners 603 as a diagonal length 608 of the channel nut between the diagonally opposed corners 603 is greater than the width of the channel of the channel strut, thus causing the two respective diagonally opposed corners 603 to abut the sidewalls of the channel strut if rotated in a left a handed direction. Once rotated the notches 214 align with the downward facing lower abutment surfaces of the channel strut. In the embodiment shown only a substantially small further right handed rotation past 90 degrees is allowed as the two diagonally opposed corners 603 abut the sidewalls of the channel strut in use.

FIGS. 7A, 7B and 7C show modes of operation of certain embodiments of the present invention. In FIG. 7A the channel nut 216 is retained between the two sidewalls and the second stop surface of the retaining portion 218 of the retainer body. The cleat 100 is positioned on the upper surface of the base plate portion 202 of the retainer body between the two upstanding protrusions 400 (only one visible) of the upper surface of the base plate portion of the retainer body. A first through hole extends through the mount and central portion of the strap of the cleat. In certain embodiments the first through hole may be counter sunk into the mount of the cleat so that the head of the bolt sits flush with upper surface of the mount. Optionally the first through hole may be formed so that the head of the bolt may be located between the upper surface and lower surface of the mount. The first through hole is substantially coaxially aligned with the second through hole that extends through the base plate portion 202 of the retainer body and both the first and second through holes are substantially coaxially aligned with the third through hole that extends through the channel nut 216. A bolt 700 with a threaded region 702 is located through the first, second and third through holes and loosely secured by tooth elements such as the ears (as seen in FIG. 3) that extend outwards from the inner surface of the second through hole extending through the retainer body thus loosely securing the retainer body to the cleat. Other suitable securing members will be known by those skilled in the art. The channel nut 216 is retained in the retaining portion 218 of the retainer body and is located in the channel of the channel strut 104 between the two spaced apart hooked ends of the channel strut via the slot like opening of the channel strut in a first rotational orientation. The retainer body and cleat are supported on the channel strut by the lower surface of the baseplate portion 202 of the retainer body abutting the upper abutment surfaces of the channel strut.

In FIG. 7B the cleat is rotated around about 90 degrees about an axis aligned with the substantially coaxially aligned first, second and third through holes. The direction of the rotation will depend on the position of the arcuate surfaces 602 (only one is shown) of the channel nut 216. In the embodiment shown the rotation 704 is in a right hand direction. Upon rotation of the cleat an outer surface of the cleat abuts the inner surface 401 of the upstanding protrusions 400 of the upper surface of the base plate portion of the retainer body. The upstanding protrusions translate the rotation 704 of the cleat into a substantially equivalent rotation of the retainer body and the channel nut retained therein. The rotation 704 orientates the channel nut lengthwise within the channel of the channel strut.

Referring to FIG. 7C, once the channel nut is located in the desired rotational orientation a rotation 706 of the bolt 700 engages the threaded region of the bolt with a corresponding threaded region of the further through hole extending through the channel nut. The rotation 706 drives the channel nut upwards towards the downwards facing lower abutment surfaces of the hooked ends 211 of the channel strut, thus leading to the notches 214 of the channel nut abutting the downward facing abutment surfaces of the channel strut and securing the cleat at a desired location on the channel strut.

Once secured to the channel strut the securing element of the cleat, for example the sides of the strap as shown in FIG. 1, are moved apart and a desired number of elongate members are inserted between the between the sides and rested on the upper surface of the mount. The sides of the strap are then moved towards each other so as to encircle the elongate members and secure them between the straps. The sides are then secured in place using a further securing member such as a bolt and nut or the like.

It will be appreciated that the embodiments described herein above describe a retainer body and clamp member as separate parts but certain aspects of the present invention may provide a retainer body and clamp member integrally formed. In such embodiments the retainer body may extend from the lower surface of the mount or the outer surface of the central portion of the strap. It will be further appreciated that in embodiments where the retainer body and the clamp member are integrally formed rotation drive elements such as the upstanding protrusions of the upper surface of the base plate portion would not be needed.

Certain embodiments of the present invention provide a cleat and any required fixings to enable the cleat to be secured to a channel strut or ladder or the like (required fixings may include one or more of bolts, channel nuts and washers). Such embodiments provide a retainer body suitable for holding the required fixings in place during shipping and installation. The cleat and retainer body are assembled with the required fixings in place in a factory before shipping or sale to a user. The user then unpacks the cleat and retainer body pre-assembled with the required fixings, locates the assembly onto the channel strut or ladder so that the channel nut is located within the channel of the channel strut, rotates the assembly and tightens a centrally located bolt securing the clamp member to the channel strut or ladder. This is far quicker than having to assemble the parts on site and quicker and cheaper than organising the logistics of ordering and shipping the separate parts of the assembly.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-57. (canceled)

58. Apparatus for securing at least one elongate member at a desired location, comprising:
a clamp member for securing at least one elongate member;
a retainer body, comprising:
a base plate portion configured for supporting a clamp member, the base plate portion comprising at least one rotation drive element located on an upper surface of the base plate portion for driving a rotation of a clamp member into a rotation of the retainer body;
a retaining portion extending from a lower surface of the base plate portion and configured for retaining a channel nut member in a desired location and rotational orientation with respect to a channel support member; and
a first through hole for receiving a first securing member, wherein the first through hole extends through the base plate portion; and
a channel nut member comprising a second through hole, wherein the channel nut member is located within the retaining portion of the retainer body.

59. The apparatus as claimed in claim 58, wherein the at least one rotation drive element comprises at least one protrusion outwardly extending from the upper surface of the base plate portion.

60. The apparatus as claimed in claim 59, wherein the protrusion comprises two substantially parallel elongate spaced apart protrusions located at opposing edges of the upper surface of the base plate portion.

61. The apparatus as claimed in claim 58, wherein the retaining portion comprises a first stop surface and a further stop surface opposed to and spaced from the first stop surface by at least one spacer element.

62. The apparatus as claimed in claim 61, wherein said spacer element and stop surfaces define an aperture for receiving the channel nut member.

63. The apparatus as claimed in claim 61, wherein the first through hole extends through at least one of the first and/or further stop surfaces.

64. A method for securing at least one elongate member, the method comprising the steps of:
locating a channel nut member at a desired location within a channel of a channel support member in a first rotational orientation, wherein the channel nut member is retained in a retaining portion of a retainer body;
rotating the channel nut member to locate the channel nut member in a further rotational orientation, whereby a rotation of the channel nut member is driven by a rotation of a clamp member located on an upper surface of a base plate portion of the retainer body;
engaging a first securing member, whereby engaging the first securing member urges the channel nut member to abut at least one channel abutment element of the channel support member;
locating at least one elongate member within the clamp member; and
securing the at least one elongate member within the clamp member.

65. The method as claimed in claim 64, further comprising the step of:
loosely securing the first securing member within a first through hole of the retaining body by providing at least one tooth element extending at least partly into the first through hole, prior to locating the channel nut member at a desired location.

66. The method as claimed in claim 65, whereby:
the rotation of the retainer body is driven, from the clamp member, by at least one rotation drive element located on an upper surface of the base plate portion of the retainer body, thereby driving rotation of the channel nut member.

67. Apparatus for retaining a channel nut member in a desired location in respect to a channel support member, the apparatus comprising:
a retainer body, comprising:
a base plate portion, for supporting a clamp member, comprising at least one rotation drive element located on an upper surface of the base plate portion for driving a rotation of a clamp member into a rotation of the retainer body;
a retaining portion, extending from a lower surface of the base plate portion, for retaining a channel nut member in a desired location and rotational orientation with respect to a channel support member; and
a first through hole for receiving a first securing member, wherein the first through hole extends through the base plate portion.

68. The apparatus as claimed in claim 67, wherein the at least one rotation drive element comprises at least one protrusion outwardly extending from the upper surface of the base plate portion.

69. The apparatus as claimed in claim 68, wherein the protrusion comprises two substantially parallel elongate spaced apart protrusions located at opposing edges of the upper surface of the base plate portion.

70. The apparatus as claimed in claim 67, wherein the retaining portion comprises a first stop surface and a further stop surface opposed to and spaced from the first stop surface by at least one spacer element.

71. The apparatus as claimed in claim 70, wherein said spacer element and stop surfaces define an aperture for receiving the channel nut member.

72. The apparatus as claimed in claim 71, wherein each spacer element comprises at least one sidewall extending between the first and further stop surfaces.

73. The apparatus as claimed in claim 72, wherein each sidewall element has a length greater than a thickness of the channel nut member.

74. The apparatus as claimed in claim 67, further comprising at least one tooth element for loosely securing a first securing member in the first through hole.

75. The apparatus as claimed in claim 70, wherein the first through hole extends through at least one of the first and/or further stop surfaces.

76. Apparatus for securing at least one elongate member at a desired location, the apparatus comprising;
a clamp member for securing at least one elongate member;
a retainer body, comprising;
a base plate portion, for supporting a clamp member;
a retaining portion, extending from a lower surface of the base plate portion, for retaining a channel nut member in a desired location and rotational orientation with respect to a channel support member; and
a first through hole for receiving a first securing member, wherein the first through hole extends through the base plate portion; and
a channel nut member, comprising a second through hole, wherein the channel nut member is located within the retaining portion of the retainer body,
wherein the clamp member and retaining body are integrally formed.

77. A method for securing at least one elongate member, comprising the steps of:
locating a channel nut member at a desired location within a channel of a channel support member in a first rotational orientation, wherein the channel nut member is retained in a retaining portion of a retainer body;
rotating the channel nut member to locate the channel nut member in a further rotational orientation, whereby a rotation of the channel nut member is driven by a rotation of a clamp member, wherein the retainer body and the clamp member are integrally formed;
engaging a first securing member, whereby engaging the first securing member urges the channel nut member to abut at least one channel abutment element of the channel support member;
locating at least one elongate member within the clamp member; and
securing the at least one elongate member within the clamp member.
